(19) United States
(12) Patent Application Publication
(10) Pub. No.: US 2022/0292644 A1
(43) Pub. Date: Sep. 15, 2022

(54) ELECTRONIC DEVICE AND IMAGE SIGNAL PROCESSING METHOD OF REMOVING BACKGROUND NOISE BASED ON SPATIAL FREQUENCY

(71) Applicants: YU-KUO CHENG, Taipei City (TW); Egis Technology Inc., Hsinchu City (TW)

(72) Inventor: Yu-Kuo CHENG, Taipei City (TW)

(21) Appl. No.: 17/641,034

(22) PCT Filed: Jan. 22, 2020
(86) PCT No.: PCT/CN2020/073706

§ 371 Date: Mar. 7, 2022

Related U.S. Application Data
(60) Provisional application No. 62/904,088, filed on Sep. 23, 2019.

(51) Int. Cl. G06T 5/00; G06T 5/50; G06V 10/30; G06V 40/10

(52) U.S. Cl. CPC G06T 5/002; G06T 5/50; G06V 10/30; G06V 40/10; G06T 2207/20224; G06T 2207/30196

(57) ABSTRACT

An electronic device and an image signal processing method of removing background noise based on spatial frequency are provided. The electronic device includes an image sensor and a processor. The image sensor senses an image of an object. The processor executes image signal processing operations of: receiving a composite image generated by the image sensor; transforming the composite image from a spatial domain to a frequency domain to obtain a composite frequency domain component; eliminating a background component, corresponding to a frequency domain noise position, from a second frequency domain component to obtain a clear frequency domain component representative of the image signal; and performing subsequent processing according to the clear frequency domain component to generate the image signal for the electronic device.

### BACKGROUND OF THE INVENTION

### Field of the Invention

This disclosure relates to an electronic device and an image signal processing method, and more particularly to an electronic device and an image signal processing method of removing background noise based on spatial frequency.

### Description of the Related Art

At present, an optical biometrics sensor, such as an optical fingerprint sensor, has been integrated with a mobile device, such as a mobile phone, and more particularly been integrated under a display screen to achieve fingerprint sensing effects, and been applied to occasions including identification, recognition and the like. The optical fingerprint sensor, such as an ultra-thin optical fingerprint sensor or a fingerprint sensor including a lens or lenses may be disposed under an organic light-emitting diode (OLED) display, a liquid crystal display (LCD) or any other display.

When these displays are designed, some fixed patterns are present. In addition, in order to provide the light transmission property, one or multiple light transmission regions are left in the display, and each light transmission region covers some circuits, wires or other structures of the display. So, a fingerprint image sensed through each light transmission region has traces corresponding to some circuits, wires or other structures, wherein the traces include, for example, #-shaped traces referred to as background noise. When the fingerprint image and the background noise are combined together, the sensed image signal includes the background noise, which is regarded as the fingerprint and processed, so the processed fingerprint image is distorted, and the subsequent image processing and identification recognition are affected. For instance, and more particularly in an application example of the LCD, some fingerprint images contain traces of concentric circles. Some background noise is present in slender textures and cuts off the fingerprint textures. That is, the pattern of the display is also incorporated into the fingerprint image, and the sensing result is affected.

### BRIEF SUMMARY OF THE INVENTION

It is therefore an objective of this disclosure to provide an electronic device and an image signal processing method of removing background noise based on spatial frequency, wherein the background noise including global non-uniformity noise, fixed pattern noise, high-frequency noise and sensor footprint noise can be effectively removed from the electronic device provided with an image sensor.

To achieve the above-identified object, this disclosure provides an electronic device including: a processor; and an image sensor, which is directly or indirectly electrically connected to the processor, and senses an image of an object, wherein the processor controls the image sensor to execute image sensing and operations of: receiving a composite image generated by the image sensor, wherein the composite image is representative of a combination of a composite background and the object, and includes composite background noise corresponding to the composite background and an image signal representative of the object; transforming the composite image from a spatial domain to a frequency domain to obtain a composite frequency domain component; eliminating a background component, corresponding to a frequency domain noise position, from the composite frequency domain component to obtain a clear frequency domain component representative of the image signal; and performing subsequent processing according to the clear frequency domain component to generate the image signal for the electronic device.

To achieve the above-identified object, this disclosure further provides an electronic device including: a processor; and an image sensor, which is electrically connected to the processor and senses an image of an object, wherein the processor controls the image sensor to execute image sensing, wherein the processor further executes operations of: receiving a background image and a composite image generated by the image sensor, wherein the background image is representative of a first background, and includes first background noise corresponding to the first background, and the composite image is representative of a combination of a second background and the object, and includes second background noise corresponding to the second background and an image signal representative of the object, wherein the first background noise and the second background noise have same or similar distribution positions; transforming the background image and the composite image from a spatial domain to a frequency domain to obtain a first frequency domain component and a second frequency domain component, respectively; analyzing the first frequency domain component to obtain a frequency domain noise position representative of the first background noise; eliminating a background component, corresponding to the frequency domain noise position, from the second frequency domain component to obtain a third frequency domain component representative of the image signal; and performing subsequent processing according to the third frequency domain component to generate the image signal for the electronic device.

This disclosure further provides an image signal processing method applied to a processor of an electronic device. The method includes steps of: receiving a background image and a composite image, wherein the background image is representative of a first background, and includes first background noise corresponding to the first background, and the composite image is representative of a combination of a second background and an object, and includes second background noise corresponding to the second background and an image signal representative of the object, wherein the first background noise and the second background noise have same or similar distribution positions; transforming the background image and the composite image from a spatial domain to a frequency domain to obtain a first frequency domain component and a second frequency domain component, respectively; analyzing the first frequency domain component to obtain a frequency domain noise position representative of the first background noise; eliminating a background component, corresponding to the frequency domain noise position, from the second frequency domain component to obtain a third frequency domain component representative of the image signal; and performing subsequent processing according to the third frequency domain component to generate the image signal for the electronic device.

This disclosure further provides an image signal processing method applied to a processor of an electronic device. The method includes steps of: receiving a composite image, wherein the composite image is representative of a combination of a composite background and an object, and includes composite background noise corresponding to the composite background and an image signal representative of the object; transforming the composite image from a spatial domain to a frequency domain to obtain a composite frequency domain component; eliminating a background component, corresponding to a frequency domain noise position, from the composite frequency domain component to obtain a clear frequency domain component representative of the image signal; and performing subsequent processing according to the clear frequency domain component to generate the image signal for the electronic device.

With the above-mentioned embodiments, it is possible to effectively remove the background noise to obtain the sensing image with the good quality, and to further solve the problem encountered by an under-display optical sensor. Furthermore, when the finger is pressing the display, most noise can be effectively removed when the display deforms or does not deform, so that the image signal obtained after the image signal processing can be adopted for the registering or identifying operation. Because the electronic device has the fixed image sensing region, two image sensing operations can be performed to achieve the function of decreasing the background noise. Because the display may include a touch function, the top surface of the display gets dirty due to the finger's touch and the background noise is caused. Adopting the image signal processing mechanism of this disclosure can also effectively solve this problem.

In order to make the above-mentioned content of this disclosure more obvious and be easily understood, preferred embodiments will be described in detail as follows in conjunction with the accompanying drawings.

### BRIEF DESCRIPTION OF THE SEVERAL VIEWS OF THE DRAWINGS

FIG. 1 is a schematic top view showing an electronic device applying an image signal processing method according to a preferred embodiment of this disclosure.

FIG. 2 is a partial cross-sectional view of FIG. 1.

FIGS. 3, 4A and 4B are flow charts showing the image signal processing method according to the preferred embodiment of this disclosure.

FIG. 5 is a block diagram showing multiple modules in a processor.

FIG. 6A shows a background image obtained by an image sensor.

FIG. 6B shows a composite image obtained by the image sensor.

FIG. 6C shows a result obtained after the background image is subtracted from the composite image.

FIG. 6D shows a result obtained using an image signal processing method of removing background noise based on spatial frequency.

FIGS. 6E to 6H show first representations of spatial frequency distributions respectively corresponding to FIGS. 6A to 6D.

FIGS. 61 to 6L show second representations of the spatial frequency distributions respectively corresponding to FIGS. 6A to 6D.

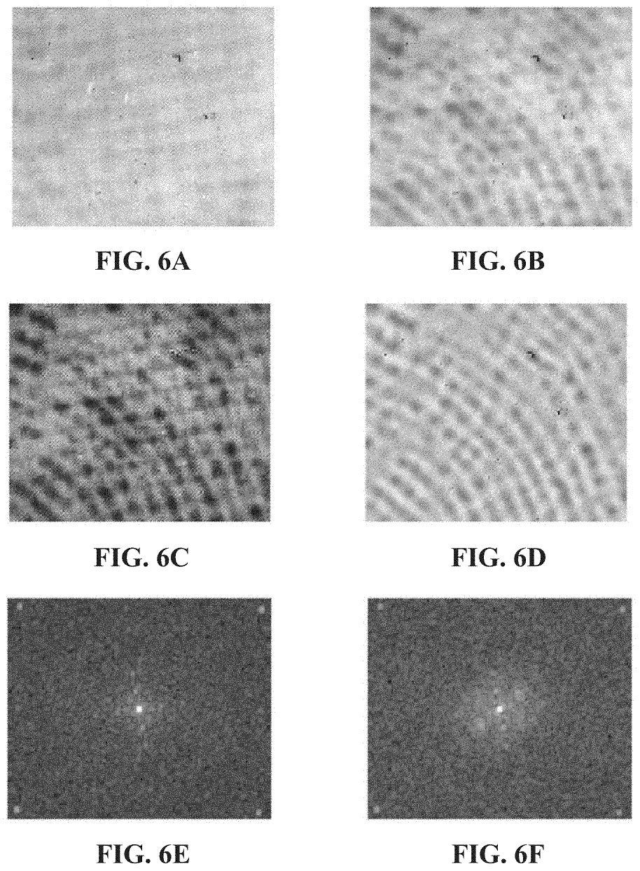

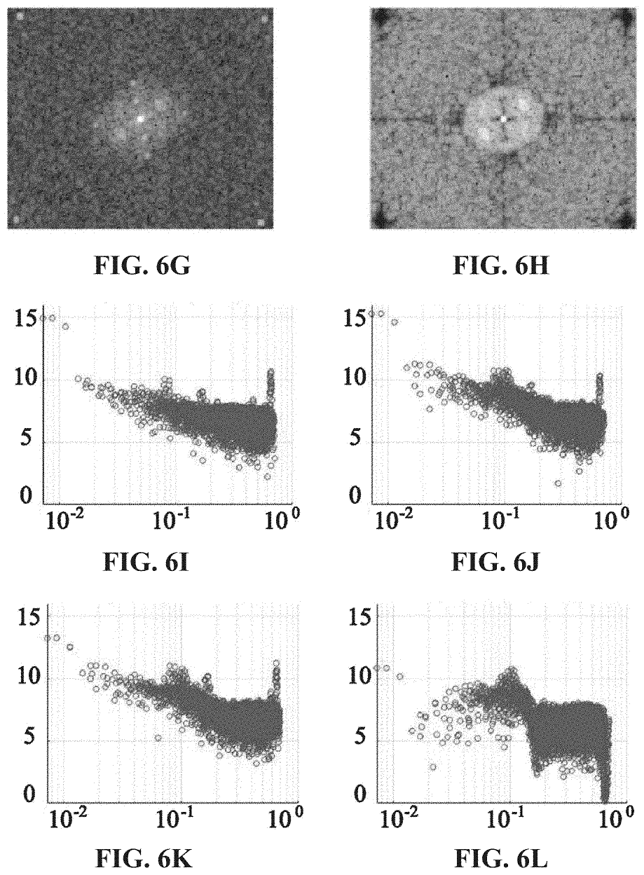

FIGS. 7A to 7L are diagrams, which have additional marks and respectively correspond to FIGS. 6A to 6L.

FIGS. 8A and 8B show enlarged views of FIGS. 7A and 7B.

### SYMBOL

BG: background image
BG1: first background
BG2: second background
BN1: first background noise
BN2: second background noise
DG: subtraction image
F: object
FC1: first frequency domain component
FC2: second frequency domain component
FC2′: second subtraction frequency domain component
FC3: third frequency domain component
FC3′: third subtraction frequency domain component
FDP: frequency domain noise position
FG: composite image
IS: image signal
NFP1, NFP2: fixed pattern noise
NGNU: global non-uniformity
NSF: sensor footprint
S10: step
S20: step
S21: step
S21′: step
S22: step
S31: step
S31′: step
SF: fingerprint signal
10: processor
11: first transforming module
11′: second transforming module
12: analyzing module
13: noise removing module
14: subsequent processing module
30: display
50: image sensor
100: electronic device

### DETAILED DESCRIPTION OF THE INVENTION

In the research process, it is found that an intensity subtraction method can be adopted to remove the background noise. However, such the method tends to eliminate the fingerprint information in the under-display fingerprint sensing occasion, so that the acceptable sensing result cannot be obtained. Therefore, this disclosure proposes an image signal processing method of removing the background noise based on spatial frequency, wherein the method may be properly applied to the under-display fingerprint sensing occasion, and may also applicable to various under-display image sensing (e.g., optical type, capacitive type, pressure type image sensing) occasions including fingerprint sensing, iris sensing, face sensing and photographing functions, or image sensing occasions having fixed background patterns.

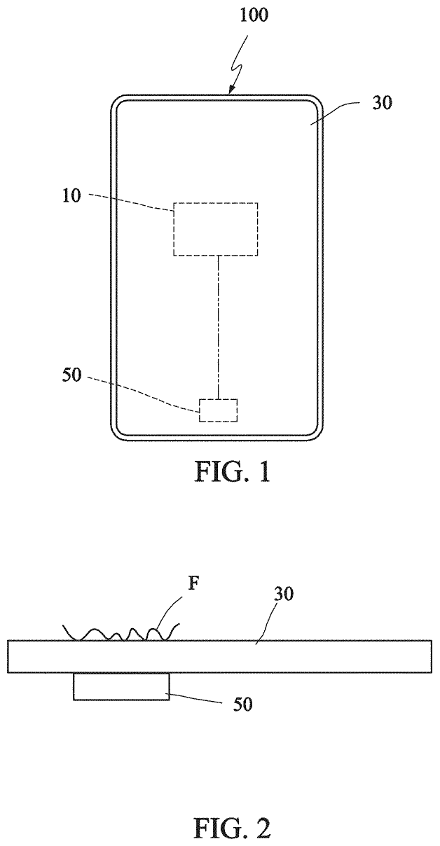

FIG. 1 is a schematic top view showing an electronic device 100 applying an image signal processing method according to a preferred embodiment of this disclosure. Referring to FIG. 1, the electronic device 100, such as a mobile device including a mobile phone, a tablet computer and the like, includes a processor 10, a display 30 and an image sensor 50. The display 30 is directly or indirectly electrically connected to the processor 10. It is worth noting that although the display 30 functioning as an element causing the background noise is explained in this embodiment, the electronic device 100 does not necessarily include the display. The architecture of the embodiment of this disclosure can be used to remove the background for elements, which cause the background noise and include, for example but without limitation to, a sensor footprint of the image sensor 50, and a casing, an inner frame, inner wires or inner elements of the electronic device 100.

The image sensor 50 is disposed under the display 30, and directly or indirectly electrically connected to the processor 10. The image sensor 50 may be a camera, a fingerprint sensor, an iris sensor, a finger vein sensor and the like. The image sensor 50 senses an image of an object F disposed on or above the display 30. The processor 10 controls the image sensor 50 to execute image sensing, controls the display operation of the display 30, and processes an image signal provided by the image sensor 50. The display 30, such as the OLED display or LCD, includes a light-transmission cover plate for protecting inner elements of the display 30. The object F includes a finger, a face, an iris, a vein and the like.

FIG. 2 is a partial cross-sectional view of FIG. 1. The object F, such as the finger, is placed on the display 30, and the image sensor 50 senses the image of the object F through the display 30. The reason for causing the background noise includes: the image sensor 50 disposed under the display 30; or the optical structure (including the lens or lenses) of the image sensor 50. Although this embodiment is explained according to the image sensor 50 being disposed under the display 30, this disclosure is not restricted thereto. In other embodiments, the image sensor 50 may also be disposed in or above the display 30, or disposed on a backside of the mobile phone. As long as the background includes the spatial frequency noise, the image signal processing method of this embodiment can be used to remove the background noise. Therefore, the image sensor 50 is not restricted to an optical type sensor, and may also be a capacitive sensor, a pressure type sensor or any other sensor.

This embodiment proposes an image signal processing method of performing calculations by way of Fourier transform and the like based on the concept of the spacial/spatial frequency. The method can analyze the spatial frequency, analyze the position of the spatial frequency, analyze which parts pertain to the spatial frequency of the fingerprint and which parts pertain to the spatial frequency of the background, and remove the spatial frequency pertaining to the background, so that only the spatial frequency pertaining to the fingerprint or the frequency domain component is left.

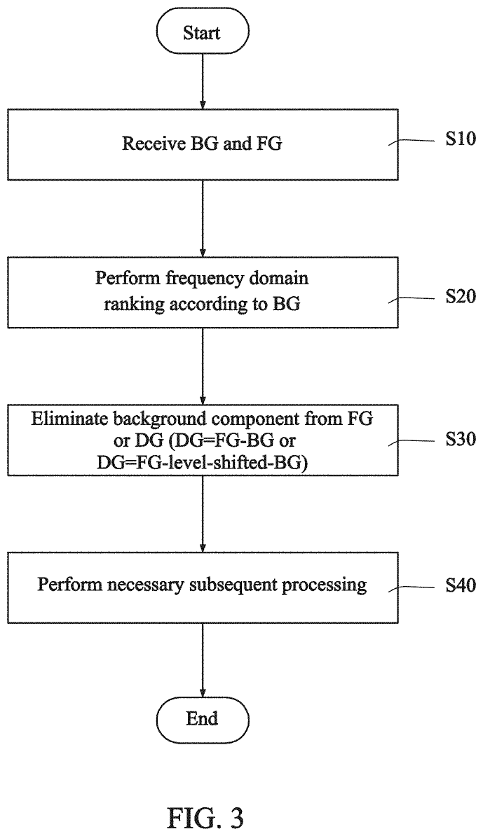

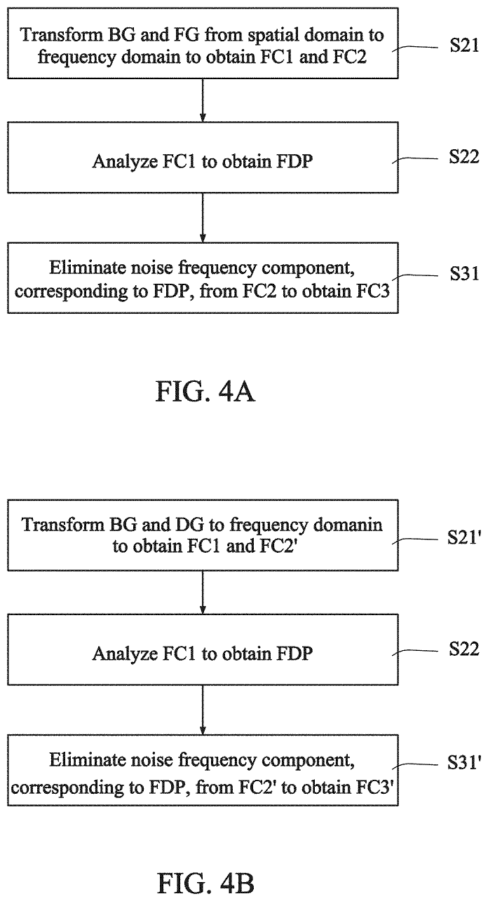

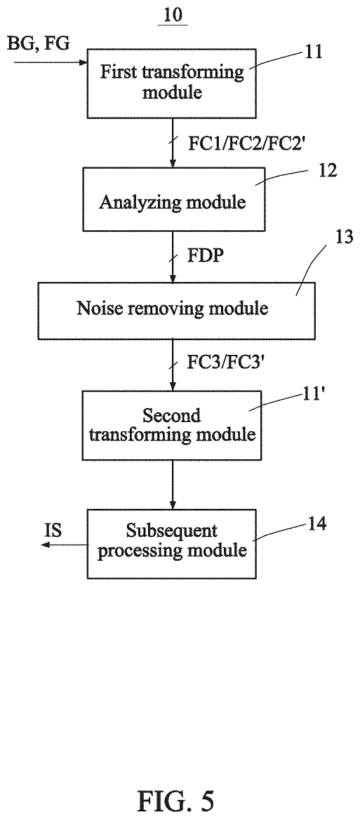

FIGS. 3, 4A and 4B are flow charts showing the image signal processing method according to the preferred embodiment of this disclosure. FIG. 5 is a block diagram showing multiple modules in the processor 10.

Referring to FIG. 5, the processor 10 includes a first transforming module 11, a second transforming module 11′, an analyzing module 12, a noise removing module 13 and a subsequent processing module 14, and is for executing the following steps. These modules are implemented by software, hardware or firmware. Referring to FIGS. 3, 4A, 4B and 5, the image signal processing method of removing background noise based on spatial frequency may be used in the processor 10 of the electronic device 100, and includes the following steps S10 to S40. The first transforming module 11 and the second transforming module 11′ may be respectively implemented by two Fourier transform modules, or may integrated into one single Fourier transform module.

In order to achieve the image signal processing of removing the noise, the processor 10 further executes the following operations. First, in the step S10, the processor 10 receives a background image BG and a composite image FG generated by the image sensor 50. The background image BG is representative of a first background BG1, and includes first background noise BN1 corresponding to the first background BG1. The composite image FG is representative of a combination of a second background BG2 and the object F, and includes second background noise BN2 corresponding to the second background BG2 and an image signal IS representative of the object F. The first background noise BN1 and the second background noise BN2 have same or similar distribution positions.

In the step S20, the analyzing module 12 determines a frequency domain noise position or positions FDP according to the background image BG. In one example, the analyzing module 12 performs frequency domain ranking according to the background image BG to analyze the frequency domain noise position FDP. In more detail, in the step S21, the first transforming module 11 transforms the background image BG and the composite image FG from a spatial domain to a frequency domain to obtain a first frequency domain component FC1 and a second frequency domain component FC2 (also referred to as a composite frequency domain component). Then, in the step S22, the analyzing module 12 is used to analyze the first frequency domain component FC1 to obtain the frequency domain noise position FDP representative of the first background noise BN1. For instance, the analyzing module 12 of the processor 10 judges the frequency domain noise position FDP according to outliers of the first frequency domain component FC1 in the frequency domain. Next, in the step S30, the noise removing module 13 is utilized to eliminate the background component, corresponding to the frequency domain noise position FDP, from the second frequency domain component FC2 to obtain a third frequency domain component FC3 (also referred to as a clear frequency domain component) (a step S31 of the step S30) representative of the image signal IS. In one example, the processor 10 subtracts the background image BG from the composite image FG to obtain a subtraction image DG. Alternatively, in another example, the processor 10 subtracts a level-shifted background image BG, level-shifted from the background image BG, from the composite image FG to obtain the subtraction image DG. It is worth noting, the noise removing module 13 may also execute low-pass notch filtering to smooth the image signal in the frequency domain. In one example, after the low-pass notch filtering in the frequency domain has been executed, the spatial domain smoothing may be omitted, or the spatial domain smoothing time can be shortened to speed up the overall image signal processing flow. Next, in the step S40, the subsequent processing module 14 performs subsequent processing according to the third frequency domain component FC3 to generate the image signal IS for the electronic device. For instance, the second transforming module 11′ may be used to transform the third frequency domain component FC3 from the frequency domain to the spatial domain, and the subsequent processing module 14 is used to perform the spatial domain image signal processing (ISP), such as image smoothing to obtain the image signal IS representative of the object F. Then, the processor 10 performs a biometrics characteristic registering operation or an identification comparison operation according to the image signal IS, and interacts with a user in conjunction with the display 30 upon registering or after the identification comparison operation passes. The above-mentioned mode may be referred to as a standard mode. With the above-mentioned architecture, the background noise removing effect according to the embodiment of this disclosure can be achieved. Other non-essential characteristics according to the embodiment of this disclosure will be further described in the following.

In summary, the embodiment of this disclosure also provides an image signal processing method being applied to the processor 10 of the electronic device 100, and including the following steps. First, the background image BG and the composite image FG are received, wherein the background image BG is representative of the first background BG1, and includes the first background noise BN1 corresponding to the first background BG1. The composite image FG is representative of the combination of the second background BG2 and the object F, and includes the second background noise BN2 corresponding to the second background BG2 and the image signal IS representative of the object F. The first background noise BN1 and the second background noise BN2 have same or similar distribution positions. Then, the background image BG and the composite image FG are transformed from the spatial domain to the frequency domain to obtain the first frequency domain component FC1 and the second frequency domain component FC2, respectively. Next, the first frequency domain component FC1 is analyzed to obtain the frequency domain noise position FDP representative of the first background noise BN1. Then, the background component corresponding to the frequency domain noise position FDP is eliminated from the second frequency domain component FC2 to obtain the third frequency domain component FC3 representative of the image signal IS. Next, subsequent processing is performed according to the third frequency domain component FC3 to generate the image signal IS for the application of the electronic device 100.

In one example, in order to perform the subsequent processing to generate the image signal IS for the electronic device, the second transforming module 11′ of the processor 10 may further transform the third frequency domain component FC3 from the frequency domain to the spatial domain and perform the spatial domain image signal processing to obtain the image signal IS representative of the object F.

In a subtraction mode, the noise frequency component may also be removed from the subtraction image DG. In the step S21′ of FIG. 4B, the processor 10 transforms the background image BG from the spatial domain to the frequency domain to obtain the first frequency domain component FC1, and subtracts the background image BG from the composite image FG or subtracts the level-shifted background image BG from the composite image FG to obtain the subtraction image DG, and transforms the subtraction image DG into a second subtraction frequency domain component FC2′. Then, the step S22 is performed. Next, in the step S31′, the background component (noise frequency component) corresponding to the frequency domain noise position FDP is eliminated from the second subtraction frequency domain component FC2′ to obtain a third subtraction frequency domain component FC3′ representative of the image signal IS. The subsequent processing module 14 performs subsequent processing according to the third subtraction frequency domain component FC3′ to generate the image signal IS for the electronic device. The processor 10 may also compare the image signals IS, obtained in two modes, with each other to determine which image signal is more beneficial to the minutia point extraction or comparison, and outputs the preferred image signal IS. It is worth noting that there are many background eliminating methods. Because the subtraction image DG and the composite image FG have different means, the background image BG may be offset or shifted by a predetermined value and then the background can be eliminated from the shifted background image BG, and the result is assigned to the subtraction image DG (i.e., DG=FG−Level-Shifted(BG)). Then, the subtraction image DG is subsequently processed. In another example, the result of (DG=FG−Level-Shifted(BG)) may also be directly provided to a notch filter or encounter the image signal processing in the spatial domain.

When the display 30 is a hard display, the object F pressing the display 30 causes no deformation of the display 30, so the background noise before the finger's pressing is the same as the background noise after the finger's pressing. Therefore, the first background noise BN1 and the second background noise BN2 are completely the same. Therefore, such the hard display provides the fixed background noise, so that the first background noise BN1 and the second background noise BN2 are completely the same, and that the background component is representative of all parts of the first background noise BN1.

When the display 30 is a non-fully hard display, the object F pressing the display 30 makes the display 30 slightly deform, so that the first background noise BN1 and the second background noise BN2 are similar to each other and are not completely the same. Therefore, such the display provides the fluctuating background noise, so that the first background noise BN1 and the second background noise BN2 are similar to each other and are not completely the same, and that the background component is representative of only a part of the second background noise BN2. Because the position of the second background noise BN2 is very close to the position of the first background noise BN1, eliminating the second background noise BN2 according to the position of the first background noise BN1 may also obtain the good image.

In one example, (DG=FG−BG) may also be determined according to the degree of reduction of the fixed pattern noise (FPN) after (FG−BG). If FPN has been completely or significantly eliminated after (FG−BG), then it is unnecessary to perform the subsequent processing in the frequency domain. When the background image BG is either eliminated or not eliminated, the subtraction image DG may be processed in the frequency domain.

The first background noise BN1 or second background noise BN2 includes one selected from a group consisting of global non-uniformity noise, fixed pattern noise, high-frequency noise and sensor footprint noise.

Upon the practical application, before the electronic device 100 performs the fingerprint sensing, the image sensor 50 firstly senses the background image BG, which may be generated before the electronic device 100 is shipped out, wherein the image sensing may also be automatically executed when the mobile phone is restarted or reset, or may be periodically automatically executed. The background image BG includes the frequency domain noise or spatial frequency. The processor of the mobile phone may obtain the position of the frequency domain noise. The background image BG corresponds to the structure patterns, wires or circuit structures of the display 30. When the mobile phone performs the fingerprint sensing, the user places his/her finger above the display 30, and the image sensor 50 performs sensing to obtain the composite image FG. The processor eliminates the component, corresponding to the position, from the composite image FG according to the position of the frequency domain noise to obtain the third frequency domain component FC3 in the frequency domain with the background being removed. Further processing is performed according to the third frequency domain component FC3 to obtain a final image to be outputted or provided to the mobile phone to perform the fingerprint registering or identifying process.

Therefore, the image sensor 50 performs background image sensing to obtain the background image BG when the object F is not located within a sensing range of the image sensor 50; and the image sensor 50 performs composite image sensing to obtain the composite image FG when the object F is located within the sensing range of the image sensor 50. Although the background image sensing is performed before the composite image sensing, the background image sensing may also be performed after the composite image sensing in another example. In this case, the display 30 can notify the user to move the finger away from the display 30.

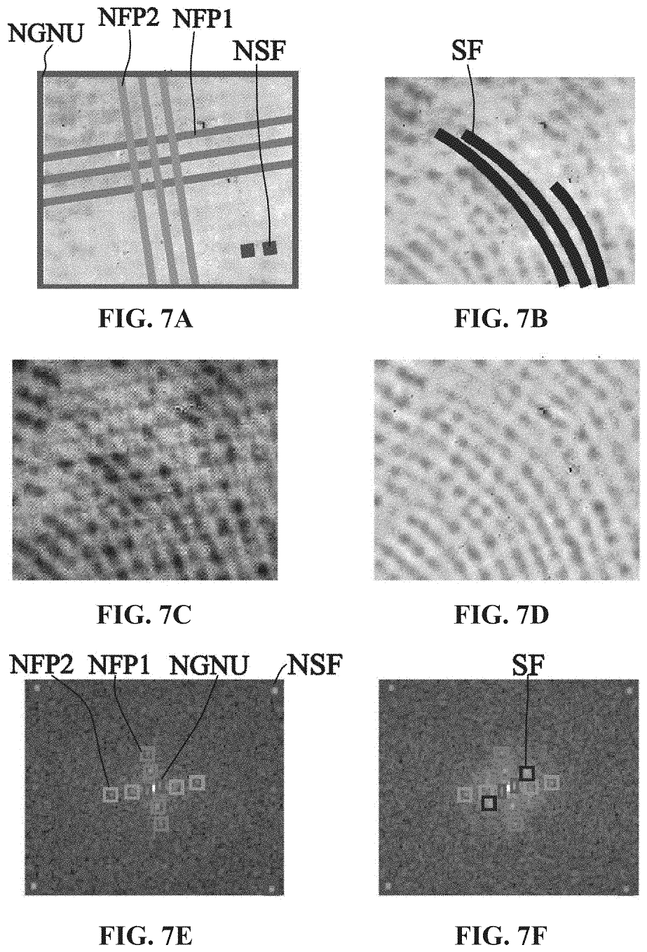

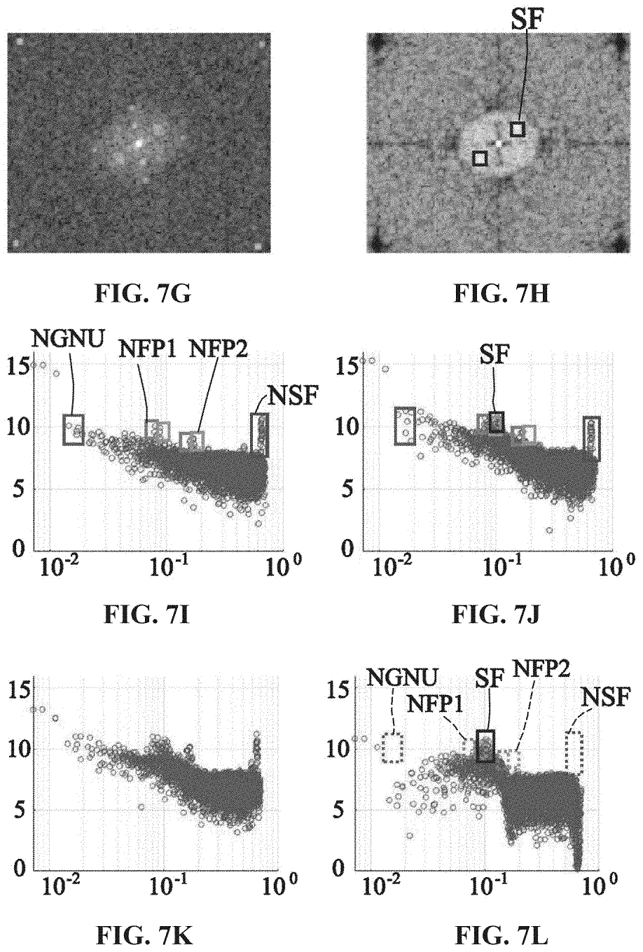

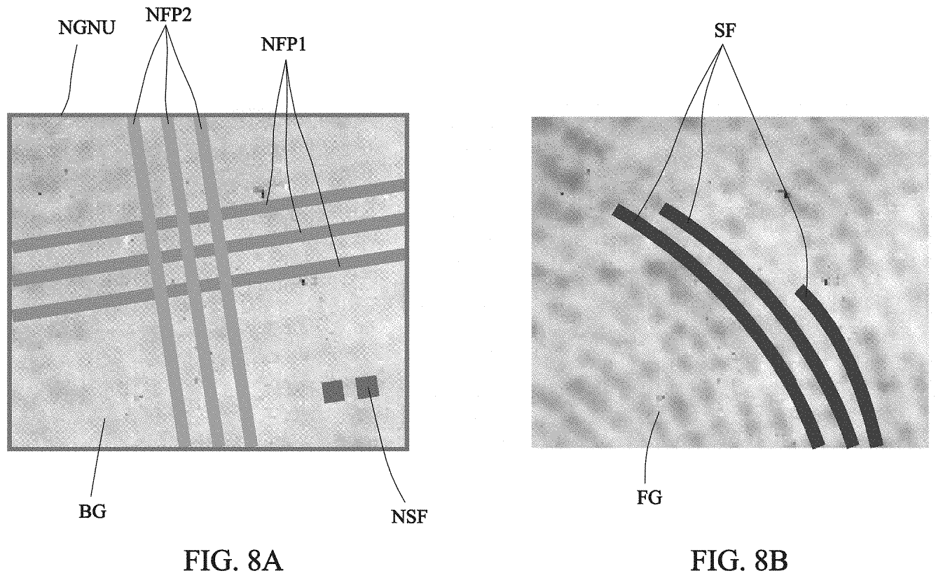

FIG. 6A shows the background image BG obtained by the image sensor 50. FIG. 6B shows the composite image FG obtained by the image sensor 50. FIG. 6C shows the result obtained after the background image BG is subtracted from the composite image FG, and it is found that the quality is not very ideal. FIG. 6D shows the result obtained using the image signal processing method of removing background noise based on spatial frequency according to this disclosure, and it is found that the quality is ideal. FIGS. 6E to 6H show first representations of spatial frequency distributions respectively corresponding to FIGS. 6A to 6D. FIGS. 61 to 6L show second representations of the spatial frequency distributions respectively corresponding to FIGS. 6A to 6D.

FIGS. 7A to 7L are diagrams, which have additional marks and respectively correspond to FIGS. 6A to 6L. FIGS. 8A and 8B show enlarged views of FIGS. 7A and 7B. Referring to FIGS. 7A to 8B, the background image BG includes background noise (including fixed pattern noise NFP1, fixed pattern noise NFP2, global non-uniformity noise NGNU and sensor footprint noise NSF), and the composite image FG includes the above-mentioned background noise (not marked) and the fingerprint signal SF. The frequency domain analysis is performed to determine the position of the background noise, and the background noise eliminated from the composite image FG in the frequency domain to obtain the frequency domain component shown in FIG. 7L, wherein the fingerprint signal SF (solid-line frame) is left, and components corresponding to the sensor footprint noise NSF (dashed-line frame), the global non-uniformity noise NGNU (dashed-line frame), the fixed pattern noise NFP1, and the fixed pattern noise NFP2 (dashed-line frame) have been removed. After the frequency domain component has been transformed into the spatial domain image, further image signal processing can be performed.

It is worth noting that although the above-mentioned embodiment is to eliminate the background component, corresponding to the frequency domain noise position FDP, from the second frequency domain component FC2 to obtain the third frequency domain component FC3 representative of the image signal IS according to the frequency domain noise position FDP of the first background noise BN1 of the first background BG1, this disclosure is not restricted thereto. In another embodiment, the processor 10 may analyze the composite frequency domain component FC2 of the composite image FG to obtain the frequency domain noise position FDP, and eliminate the background component, corresponding to the frequency domain noise position FDP, from the second frequency domain component FC2 of the composite image FG according to the frequency domain noise position FDP. In this case, the background image BG is not needed, and the function of removing the background noise still can be achieved by sensing only one composite image FG. Alternatively, the frequency domain noise position FDP may be obtained upon testing before the electronic device is shipped out, and stored in a storage (not shown) of the electronic device 100. The processor 10 only needs to directly access the stored frequency domain noise position FDP to achieve the effect of removing the background noise.

Therefore, this embodiment provides an electronic device 100 including the processor 10 and the image sensor 50. The image sensor 50 is directly or indirectly electrically connected to the processor 10 and senses the image of the object F. The processor 10 controls the image sensor 50 to execute image sensing and operations of: receiving the composite image FG generated by the image sensor 50, wherein the composite image FG is representative of the combination of the composite background BG2 and the object F, and includes the composite background noise BN2 corresponding to the composite background BG2 and the image signal IS representative of the object F; transforming the composite image FG from the spatial domain to the frequency domain to obtain the composite frequency domain component FC2; eliminating the background component, corresponding to the frequency domain noise position FDP, from the composite frequency domain components FC2 to obtain the clear frequency domain component FC3 representative of the image signal IS; and performing subsequent processing according to the clear frequency domain component FC3 to generate the image signal IS for the electronic device.

The embodiment, in which no corresponding background image is needed, provides an image signal processing method applied to the processor 10 of the electronic device 100. The method includes steps of: receiving the composite image FG, wherein the composite image FG is representative of the combination of the composite background BG2 and the object F, and includes the composite background noise BN2 corresponding to the composite background BG2 and the image signal IS representative of the object F; transforming the composite image FG from the spatial domain to the frequency domain to obtain the composite frequency domain component FC2; eliminating the background component, corresponding to the frequency domain noise position FDP, from the composite frequency domain components FC2 to obtain the clear frequency domain component FC3 representative of the image signal IS; and performing subsequent processing according to the clear frequency domain component FC3 to generate the image signal IS for the application of the electronic device 100.

With the above-mentioned embodiments, it is possible to effectively remove the background noise to obtain the sensing image with the good quality, and to further solve the problem encountered by an under-display optical sensor. Furthermore, when the finger is pressing the display, most noise can be effectively removed when the display deforms or does not deform, so that the image signal obtained after the image signal processing can be adopted for the registering or identifying operation. Because the electronic device has the fixed image sensing region, two image sensing operations can be performed to achieve the function of decreasing the background noise. Because the display may include a touch function, the top surface of the display gets dirty due to the finger's touch and the background noise is caused. Adopting the image signal processing mechanism of this disclosure can also effectively solve this problem.

The specific embodiments proposed in the detailed description of this disclosure are only used to facilitate the description of the technical contents of this disclosure, and do not narrowly limit this disclosure to the above-mentioned embodiments. Various changes of implementations made without departing from the spirit of this disclosure and the scope of the claims are deemed as falling within the following claims.

1. An electronic device of removing background noise based on spatial frequency, the electronic device comprising:
a processor; and
an image sensor being directly or indirectly electrically connected to the processor and sensing an image of an object, wherein the processor controls the image sensor to execute image sensing and operations of:
receiving a composite image generated by the image sensor, wherein the composite image is representative of a combination of a composite background and the object, and comprises composite background noise corresponding to the composite background and an image signal representative of the object;
transforming the composite image from a spatial domain to a frequency domain to obtain a composite frequency domain component;
eliminating a background component, corresponding to a frequency domain noise position, from the composite frequency domain component to obtain a clear frequency domain component representative of the image signal; and
performing subsequent processing according to the clear frequency domain component to generate the image signal for the electronic device.

2. The electronic device according to claim 1, wherein the processor analyzes the composite frequency domain component to obtain the frequency domain noise position.

3. The electronic device according to claim 1, wherein:
the processor further receives a background image generated by the image sensor, wherein the background image is representative of a first background, and comprises first background noise corresponding to the first background;
the composite background is defined as a second background, the composite background noise is defined as a second background noise, and the first background noise and the second background noise have same or similar distribution positions;
the composite frequency domain component is defined as a second frequency domain component, and the clear frequency domain component is defined as a third frequency domain component;
the processor further transforms the background image from the spatial domain to the frequency domain to obtain a first frequency domain component; and
the processor analyzes the first frequency domain component to obtain the frequency domain noise position.

4. The electronic device according to claim 3, wherein the processor comprises:
a transforming module transforming the background image and the composite image from the spatial domain to the frequency domain, and transforming the third frequency domain component from the frequency domain to the spatial domain;
an analyzing module analyzing the first frequency domain component to obtain the frequency domain noise position; and
a noise removing module eliminating the background component, corresponding to the frequency domain noise position, from the second frequency domain component to obtain the third frequency domain component.

5. The electronic device according to claim 3, wherein the first background noise and the second background noise are completely the same.

6. The electronic device according to claim 5, wherein the background component is representative of all parts of the first background noise.

7. The electronic device according to claim 3, wherein the first background noise and the second background noise are similar to each other and are not completely the same.

8. The electronic device according to claim 7, wherein the background component is representative of a part of the second background noise but not all parts of the second background noise.

9. The electronic device according to claim 3, wherein each of the first background noise and the second background noise comprises one selected from a group consisting of global non-uniformity noise, fixed pattern noise, high-frequency noise and sensor footprint noise.

10. The electronic device according to claim 3, wherein the processor further transforms the third frequency domain component from the frequency domain to the spatial domain and performs spatial domain image signal processing to obtain the image signal representative of the object.

11. The electronic device according to claim 3, wherein the image sensor performs background image sensing when the object is not located within a sensing range of the image sensor to obtain the background image; and the image sensor performs composite image sensing to obtain the composite image when the object is located within the sensing range of the image sensor.

12. The electronic device according to claim 11, wherein the background image sensing is automatically executed before the electronic device is shipped out, upon resetting or restarting; or is periodically automatically executed.

13. The electronic device according to claim 11, wherein the background image sensing is executed before the composite image sensing.

14. The electronic device according to claim 1, wherein the object comprises a finger, a face, an iris or a vein.

15. The electronic device according to claim 3, further comprising a display directly or indirectly electrically connected to the processor, wherein the image sensor is disposed under the display and senses the image of the object disposed on or above the display, and the processor further controls a display operation of the display.

16. The electronic device according to claim 15, wherein the display is a hard display having no deformation when the object presses the display, so that the first background noise and the second background noise are completely the same.

17. The electronic device according to claim 15, wherein the display is a non-fully hard display, and the display slightly deforms when the object presses the display, so that the first background noise and the second background noise are similar to each other and are not completely the same.

18. The electronic device according to claim 15, wherein the processor performs a biometrics characteristic registering operation or an identification comparison operation according to the image signal, and interacts with a user in conjunction with the display upon the biometrics characteristic registering operation or after the identification comparison operation passes.

19. The electronic device according to claim 3, wherein the processor judges the frequency domain noise position according to outliers of the first frequency domain component in the frequency domain.

20. The electronic device according to claim 3, wherein in a subtraction mode: the processor subtracts the background image from the composite image or subtracts the background image, which is level-shifted, from the composite image to obtain a subtraction image; the processor transforms the subtraction image to a second subtraction frequency domain component; then the processor eliminates the background component, corresponding to the frequency domain noise position, from the second subtraction frequency domain component to obtain a third subtraction frequency domain component representative of the image signal; and the processor performs the subsequent processing according to the third subtraction frequency domain component to generate the image signal for the electronic device.

21. An image signal processing method applied to a processor of an electronic device the image signal processing method comprising steps of:
receiving a composite image, which is representative of a combination of a composite background and an object, and comprises composite background noise corresponding to the composite background and an image signal representative of the object;
transforming the composite image from a spatial domain to a frequency domain to obtain a composite frequency domain component;
eliminating a background component, corresponding to a frequency domain noise position, from the composite frequency domain component to obtain a clear frequency domain component representative of the image signal; and
performing subsequent processing according to the clear frequency domain component to generate the image signal for the electronic device.

22. The image signal processing method according to claim 21, wherein the processor analyzes the composite frequency domain component to obtain the frequency domain noise position.

23. The image signal processing method according to claim 21, further comprising steps of:
receiving a background image, which is representative of a first background, and comprises first background noise corresponding to the first background, wherein the composite background is defined as a second background, the composite background noise is defined as a second background noise, the first background noise and the second background noise have same or similar distribution positions, the composite frequency domain component is defined as a second frequency domain component, and the clear frequency domain component is defined as a third frequency domain component;
transforming the background image from the spatial domain to the frequency domain to obtain a first frequency domain component; and
analyzing the first frequency domain component to obtain the frequency domain noise position.

24. The image signal processing method according to claim 23, wherein the first background noise and the second background noise are completely the same.

25. The image signal processing method according to claim 24, wherein the background component is representative of all parts of the first background noise.

26. The image signal processing method according to claim 23, wherein the first background noise and the second background noise are similar to each other and are not completely the same.

27. The image signal processing method according to claim 26, wherein the background component is representative of a part of the second background noise but not all parts of the second background noise.

28. The image signal processing method according to claim 23, wherein each of the first background noise and the second background noise comprises one selected from a group consisting of global non-uniformity noise, fixed pattern noise, high-frequency noise and sensor footprint noise.

29. The image signal processing method according to claim 23, further comprising steps of:
transforming the third frequency domain component from the frequency domain to the spatial domain, and performing spatial domain image signal processing to obtain the image signal representative of the object.

30. The image signal processing method according to claim 23, further comprising steps of:
using an image sensor of the electronic device to perform background image sensing to obtain the background image when the object is not located within a sensing range of the image sensor; and
using the image sensor to perform composite image sensing to obtain the composite image when the object is located within the sensing range of the image sensor.

31. The image signal processing method according to claim 23, wherein in a subtraction mode: the background image is subtracted from the composite image, or the background image, which is level-shifted, is subtracted from the composite image to obtain a subtraction image; the subtraction image is transformed to a second subtraction frequency domain component; and then the background component, corresponding to the frequency domain noise position, is eliminated from the second subtraction frequency domain component to obtain a third subtraction frequency domain component representative of the image signal; and the subsequent processing is performed according to the third subtraction frequency domain component to generate the image signal for the electronic device.
